(19) United States
(12) Patent Application Publication
(10) Pub. No.: US 2008/0280760 A1
(43) Pub. Date: Nov. 13, 2008

(54) Composite Growth Media for Plant Propagation

(76) Inventor: John F. Oliver, Greenville, SC (US)

Correspondence Address: DORITY & MANNING, P.A., POST OFFICE BOX 1449, GREENVILLE, SC, 29602-1449, US

(21) Appl. No.: 11/745,523

(22) Filed: May 8, 2007

(51) Int. Cl. A01N 65/00; C05F 11/00

(52) U.S. Cl. 504/101; 504/113; 71/23

(57) ABSTRACT

Disclosed are growth media that can be applied to soil surfaces and utilized to protect, feed, and encourage growth and development of plants, such as grass. Growth media can include a hygroscopic particulate material as well as a hygroscopic fibrous component. Media can include an adhesive as may be used to bind fibers to one another and encourage stability of the medium following application to a ground surface. Growth media can include additional materials such as seeds, fertilizers, pesticides, soil conditioners, and the like. Growth media can be completely organic and can retain moisture and structure so as to provide long term protection and nutrient deliver to developing plants.

### BACKGROUND

Methods and materials for encouraging plant growth have been developed throughout the course of history. Simple hand seeding followed by the application of a second material such as straw or an anti-flow-out fence to prevent seed and soil loss has been known. Development of more efficient materials and methods such as hydroseeding and the use of artificial seed beds have enabled increased plant propagation.

Hydroseeding, also termed hydromulching, includes premixing a mulch material, optionally also with seeds and/or fertilizer, into an aqueous slurry that can be sprayed onto prepared ground. The mulch often includes fibers or flake material formed of wood or paper. Hydroseeding compositions have also been developed to include various adhesives, particularly in conjunction with synthetic polymeric fibers, to improve stability of the material following application to the prepared soil (see, e.g., U.S. Pat. Nos. 6,806,298 to Nachtman, et al. and U.S. Pat. No. 6,349,499 to Spiftle).

Artificial seed beds, such as those disclosed by Abitz, et al. (U.S. Pat. No. 7,059,083), Ishikawa, et al. (U.S. Pat. No. 6,219,965) and Kimberlin, et al. (U.S. Pat. No. 6,929,425) are multi-layer, preformed composite structures including outer, usually degradable layers that allow water flow therethrough and an inner layer that includes the seeds often in conjunction with fibers, mulch, peat, or the like to better hold, feed and promote germination of the seeds.

As increased awareness of the dangers of synthetic materials has grown, for instance ground and water pollution upon decomposition of synthetic fabrics and mulches, it has become more favorable to better utilize natural materials to encourage plant propagation. Coconut coir pith, obtained during the extraction of coir fiber from the coconut husk, is very light, highly compressible and highly hygroscopic. At one time coir pith was considered merely a waste product of coconut production, but it has found use as a plant growth medium in recent times. For example, peat moss and coir pith have been combined to provide growth media having improved characteristics as compared to either material used alone, as described by Kusey, et al. in U.S. Pat. No. 6,189,260. Coir pith has also been combined with other materials such as composted yard waste; composted bark; composted manure; sand; peat humus; composted agricultural waste; composted animal byproducts; treated sewage sludge; animal and/or vegetable-based landfill waste as well as various surfactants to form plant propagation materials (see, e.g., U.S. Pat. No. 6,711,850 to Yelanich and U.S. Pat. No. 6,408,568 to Kusey, et al.)

While improvements have been made in the field of plant propagation, room for further improvement exists. For instance, what is needed in the art are ecologically-friendly plant propagation materials that can provide excellent growth media for plants developed therein. What is also need in the art are materials that can improve the constitution of the soil to which they are applied.

### SUMMARY

In one embodiment, a composite growth medium is disclosed. The growth medium can include a particulate component and a fibrous component. The particulate can generally have a size between about 0.2 millimeters and about 2 millimeters, a density of between about 40 lbs/ft³ and about 50 lbs/ft³ at about 20% moisture content when compressed at a ratio of 5:1 on volume to volume basis, and a water holding capacity greater than about 50%. The fibers of the fibrous component can be absorbent. For instance, they can be capable of absorbing greater than about 50% of their weight in water without loss of structure. In general, the fibers can have a length of between about one inch and about three inches.

For example, in one embodiment, the particulate component can comprise coir pith and the fibrous component can comprise short mattress fibers of the coconut husk.

The growth medium can include additional components as well. For example, a growth medium can include any or all of an adhesive, one or more plant seed types, an insecticide, and a fertilizer. In one preferred embodiment, all of the components of a growth medium can be organic.

Also disclosed are methods of utilizing the disclosed growth media. For example, a growth medium as described herein can be applied to a ground surface and can improve the health and consistency of the soil, as well as promote the growth of any plants located at the site. Growth media can be applied at a site according to any methods, e.g., as a dry mixture, in a slurry, or as a preformed mat.

### DETAILED DESCRIPTION

Reference will now be made in detail to various embodiments of the disclosed subject matter, one or more examples of which are set forth below. Each embodiment is provided by way of explanation of the disclosed subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used with another embodiment to yield a still further embodiment.

In general, the presently disclosed subject matter is directed to composite growth media for use in horticulture. The disclosed media can protect, feed, and encourage fast and healthy development of seeds or plants placed in the media. The media can provide excellent moisture retention without loss of air porosity. Loss of porosity in growth media, for instance through compaction, can lead to smothering and death of developing plants. Due to the beneficial characteristics of the disclosed materials, they can be applied at higher density than previously known growth media, leading to improved weed suppression and better long term protection and feeding of developing plants.

The disclosed media can also improve the base soil. For instance, the coordinated effects of the components of the media can break up and aerate the soil while providing desired nutrients and pH balancing materials. As such, the disclosed materials can be utilized in one embodiment to improve soil consistency and health.

The disclosed composite growth media can include a hygroscopic particulate component. The particulate can generally have a size (i.e., the diameter of a spherical particulate or the major axis of a non-spherical particulate) of between about 0.2 millimeters (mm) and about 2 mm. A particulate as may be utilized in the disclosed materials can have a density of between about 40 lbs/ft³ and about 50 lbs/ft³ at about 20% moisture content when compressed at a ratio of 5:1 on volume to volume basis and a density of between about 20 lbs/ft³ and about 30 lbs/ft³ when fluffed and at a 50-55% moisture content.

A particulate of the disclosed media can be highly hygroscopic. For instance, a particulate can absorb more than about 5 times its weight in water, or higher absorbance in other embodiments, for instance, greater than about 6 times its weight in water, or greater yet, for instance greater than about 8 times its weight in water in one embodiment. Moreover, a particular can also have a high water holding capacity (WHC, i.e., [(the weight of the material at saturation−the dry weight of the material)/(the dry weight of the material)]×100). For example, a particulate material can have a WHC of greater than about 50%, or greater than about 65%, in one embodiment.

In addition, a particulate material can have a high air porosity (obtained via, e.g., determination of the volume of water gravity-drained from a sample when obtaining the WHC). For instance, a particulate material can have an air porosity greater than about 15% of the total sample volume in one embodiment, or greater than about 20%, in another embodiment.

In addition, a particulate material as may be utilized in the disclosed media can retain desirable hygroscopic and absorption characteristics even after drying. That is, after a wet/dry cycle, a particulate material of the disclosed growth media can retain absorption and WHC characteristics as described above.

In one preferred embodiment, a particulate component can be a naturally derived material. For example, a particulate component can be coir pith, also commonly referred to as coir dust or cocopeat. Coir pith as may be utilized herein can be derived of any coconut species. Moreover, suitable coir pith may be pretreated according to any standard processing method. For example, coir pith may be aged, washed, dried, and/or compacted according to standard processes as are generally known to one of skill in the art. In general, however, compressed coir pith, such as is often formed and transported in the form of bricks, can be decompressed prior to combining with other materials of a composite growth medium. For instance, coir pith bricks can be decompressed as described by Ellis (U.S. Pat. No. 5.839,674, incorporated herein by reference).

Composite growth media as disclosed herein can also include a fibrous component. In general, the fibrous component can be formed of an ecologically friendly material. For instance, the fibrous component can be formed of a natural fiber or can be biodegradable into ecologically benign degradation products. In one embodiment, fibers of the composite can exhibit water retention characteristics and can provide increased water absorption and retention characteristics to the growth medium.

Fibers can generally be less than about 4 inches in length, for instance less than about 3 inches in length. In one embodiment, fibers can be between about one inch and about three inches in length. Suitable fibers can also be absorbent. For instance, the fibers can absorb more than about 50% of their weight in water without loss of structure. In one embodiment, the fibers can absorb between about 100% and about 150% of their weight in water without loss of structure.

In one preferred embodiment, the fibrous component can include short coconut coir fibers commonly referred to as mattress fibers. Mattress fibers as may be utilized can be obtained from either ripe (e.g., brown fiber) or immature (e.g., white fiber) coconut husks.

In one embodiment, the composite media can include the particulate component and the fibrous component in a ratio of between about 4:1 by weight of the materials and about 2:1 by weight. In one embodiment, the particulate component:fibrous component ratio can be about 3:1 by weight. The invention is not limited to these particulate:fiber ratios, however, and in other embodiments, the composite can include more fiber. For instance, in other embodiments, a composite can include the particulate component and the fibrous component in a ratio of between about 1:4 and about 1:2, for instance about 1:3. In general, the preferred ratio of particulate component to fibrous component can depend at least in part upon the method utilized to apply the composite mixture, discussed in more detail below.

The growth media can also include an adhesive. Either synthetic or natural adhesives can be used. However, in those embodiments in which synthetic adhesives are used, synthetic adhesives that can degrade to form ecologically friendly components such as, for example, nitrogenous fertilizer components such as condensates, e.g., formaldehyde condensates of urea, biurea, guanidine, and the like can be preferred. Examples of synthetic adhesives suitable for use in the disclosed growth media can include, without limitation, epoxy and novolac resins, phenol/formaldehyde condensates, melamine/formaldehyde condensates, biurea/formaldehyde condensates, urea/formaldehyde condensates, guanidine/formaldehyde condensates, and the like.

In one preferred embodiment, natural adhesives can be utilized. Examples of natural adhesives can include, without limitation, modified or unmodified starches, sugars, syrups, gums, and the like. Natural and/or chemically modified natural adhesives can be utilized including fructose, sucrose, molasses process residue, carboxymethylcellulose, hide glue, fish glue, shellac, mucilage, psyllium, gum tragacanth, gum acacia, guar gum, corn starch, arrowroot starch, montan wax, carnauba wax, beeswax, and the like.

One or more adhesives can be added in an amount so as to adhere fibers of media to one another and form a stable three dimensional matrix and incorporate the particulate component of the medium within the matrix either through adhesion, physical entrapment, or a combination of both. For example, a growth medium can include an adhesive in an amount of less than about 10% by weight of the medium. In another embodiment, a growth medium can include an adhesive in an amount of less than about 7% by weight of the medium, for instance between about 2% and about 6% by weight of the medium. In other embodiments, however, a growth medium can include higher levels of adhesive. For instance, in other embodiments, a composition as disclosed herein can include up to about 20% by weight of an adhesive, or even higher, in other embodiments.

A growth medium can include additional components that can generally be determined based upon the desired location, utilization, application process, etc. of the medium. For instance, in one embodiment, a growth medium can be combined with seeds prior to application.

Seed for inclusion in a growth medium can be any type of seed that meets the needs of the desired application. For example, any known grass seed or combination thereof can be included in a composition. As is known in the art, the desired grass seed or combination thereof can generally be dictated by the type of grass to be grown and the geographical location where the grass will be established.

Seeds for inclusion in a composite growth medium are not limited to grass seed. Other types of seeds, for instance those used for growing flowers and vegetables, could also be incorporated, optionally with other types of seeds, within a composite growth medium.

When seeds are included, a growth medium can generally include one or more types of seeds in an amount of less than about 10% by weight of the medium. For instance, a growth medium can include seeds in an amount of less than about 8% by weight of the medium. This is not a requirement of the disclosed materials, however, and a growth medium can include seed at higher addition rates in other embodiments.

A composite growth medium as disclosed herein can include one or more insecticides. Many suitable insecticides are known in the art as may be incorporated into the composite. In general, the preferred insecticide for any particular embodiment will depend upon the local climate, insect population, the plants to be protected, etc. In one preferred embodiment, a growth medium can include an organic pesticide. Organic pesticides, i.e., pesticides derived from natural sources, can include, without limitation, neem powder, diatomaceous earth, crushed crab shells, and the like.

In one embodiment, a growth medium can include an insecticide in an amount of less than about 15% by weight of the medium. Due to their ecologically benign nature, organic insecticides can generally be included in a composite at a higher amount as compared to many less ecologically-friendly insecticides. For instance, in one embodiment, an organic insecticide can be included in an amount of between about 10 and about 20% by weight of the composition.

A growth medium can include one or more natural and/or chemical fertilizers as are generally known in the art. A fertilizer can be combined with the other components of a growth medium as a powder or in a liquid form. For example, a fertilizer can be added as a liquid that can be sprayed onto one or more other components of the composite. For instance, a liquid fertilizer can be sprayed directly onto seeds prior to combination of the seeds with the other components of a growth medium such that the fertilizer covers the seeds. Such coatings are disclosed in U.S. Pat. Nos. 6,209,259 to Madigan et al. and U.S. Pat. No. 4,753,035 to RVan et al., both of which are incorporated herein by reference. Coating the seeds with a fertilizer (as well as other nutrients, as desired) can also increase the proximity of the fertilizer to the seeds and can allow the seeds to use the nutrients more efficiently as well as reduce the amount of additives in a growth medium.

In one embodiment, a fertilizer can include slow release nitrogen, as is known in the art, so that the initial sprouts from the seed will not be burned. A fertilizer can also be high in phosphorus and potassium to provide stimulation for good root development. As is known in the art, a preferred fertilizer can vary depending upon the soil type, the particular application of the growth medium, e.g., the vegetation being grown, and the local climate.

In one preferred embodiment, a fertilizer for inclusion in a composite growth medium can be an ecologically-friendly or organic fertilizer in which the nutrients contained in the product are derived solely from the remains or a by-product of an organism. Exemplary organic fertilizers for use in the disclosed growth media can include, without limitation, cottonseed meal, blood meal, fish emulsion, manure, sewage sludge and the like.

A growth medium can include other components as are generally known in the art for use as soil conditioners such as pH balancers, growth enhancement additives, germination aids, detritus materials such as grass clippings and/or hay, dyes, and the like. Such materials can generally be included in a composite in an amount as is generally known in the art, which can depend, as is known, upon the starting soil conditions, desired plants to be grown, local climate, and so on.

One embodiment of a growth medium composition as described herein is described below in Table 1.

TABLE 1

| Component | Weight percentage |
|---|---|
| Coir pith | 41 |
| Coir short fiber | 13 |
| Lawn seed | 7 |
| Lime/calcium | 15 |
| Organic fertilizer | 6 |
| Neem powder | 12 |
| Guar tack | 5 |

The components of a growth medium can be combined and applied to a location according to any suitable method. For instance, in one embodiment, the components of a composite medium can be mixed to form a dry mixture of materials. The dry mixture can then be applied to the ground as formed. A dry mixture can be applied in an amount of greater than about 50 pounds per 100 square feet of application area, for instance between about 50 and about 100 pounds per 1000 square feet of application area. In one embodiment, the materials can be applied in an amount of between about 70 and about 90 pounds per 1000 square feet of application area.

Beneficially, the disclosed media can be applied to ground at higher densities than many previously known growth media. For instance, previously known artificial mulch materials can usually be applied to ground at densities of less than about 50 pounds per 1000 square feet of application. At higher rates, these previously known materials exhibit excessive compaction upon wetting, which can stifle and suffocate developing seedlings.

While not wishing to be bound by any particular theory, it is believed that the presently disclosed media can be applied at much higher densities at least due to the fact that the particulate and fibrous components of the media can retain their wetting characteristics throughout multiple wet/dry cycles. For example, the water holding capacity, the air porosity, and other hygroscopic characteristics of the particulate component and the fibrous component can be retained throughout multiple wet/dry cycles. As such, the protective matrix formed by the media can continue to feed and protect the soil to which it is applied, as well as any germinating seeds, throughout the decomposition process of the media, without stifling growth of the developing plants.

As mentioned, in one embodiment, a growth medium can be pre-mixed and applied dry to a ground surface. According to this embodiment, the dry mixture can be spread according to any method as is known in the art, e.g., simple hand spreading, use of mechanized dry spreaders, etc. Following or prior to spreading, any additional materials to be applied to the area can be applied. For instance, in those embodiments in which the pre-formed mixture does not include seed, one or more types of seed can be spread in conjunction with the spreading of the growth medium.

In one embodiment, a composite growth medium can be applied, either with our without seeds included in the medium, on and/or around existing plants. For instance, growth medium can be applied as a mulch over and/or around pre-existing plants. Similarly, in addition to or in place of locating seeds in the medium, plants can be located in the medium, or in the soil underlying the medium, prior to or following application of the composite growth medium to the ground surface.

In general, water can be applied to the medium following spreading. For instance, the area can be watered with an ground sprinkler system. The addition of water to a medium can instigate adherence of the fibrous components of the mixture to one another, for instance through wetting of an adhesive contained in the mixture. Addition of water to the medium can also soften the underlying soil and/or can drive components of the mixture, for instance, the particulate component, fertilizers, soil conditioners, etc., into closer contact with the underlying soil. For instance, as particulate components of the growth media work down and into the soil, the soil can become better aerated, leading to improved soil consistency and overall health.

In another embodiment, the mixture can be combined with water prior to application to a soil surface. According to this particular embodiment, a composite mixture can be formed into a slurry and applied to the ground as such in a hydroseeding or hydromulching process. For example, a slurry describing a solids content of between about 5 and about 20% solids content by weight can be formed by mixing components of a growth medium as described above with a suitable amount of water. In one embodiment, a slurry can described a solids content of between about 7 and about 15 wt. %, for instance about 10 wt. %.

According to one embodiment, a composite designed for spreading as a dry mixture or in a slurry form can include relatively higher amounts of the particulate component as compared to the fibrous component. For example, a growth medium intended to be spread as a dry mixture or as an aqueous slurry can include the particulate component and the fibrous component in a ratio of between about 4:1 by weight and about 2:1 by weight, for instance in a ratio of about 3:1 by weight.

A slurry can be spread over the desired soil in one embodiment according to standard hydromulching methods. Such methods are generally known in the art and as such are not described in excessive detail herein. For example, portable equipment useful for spraying aqueous slurries of seed and fertilizer and methods of spraying are described in U.S. Pat. No. 3,091,436 to Finn, U.S. Pat. No. 3,292,307 to Finn, and U.S. Pat. No. 5,884,570 to Lincoln, all of which are incorporated herein by reference.

In another embodiment, a composite growth medium as described herein can be formed into transportable sheets or mats and can be applied to a ground surface as such. For instance, in one embodiment, a composite mixture as described above can be formed including a high level of adhesive. For instance, a composite mixture including between about 5% and about 20% adhesive by weight of the mixture can be formed, for instance between about 10 wt. % and about 15 wt. %. According to this embodiment, a composite designed for forming a cohesive mat can include relatively higher amounts of the fibrous component as compared to the particulate component. For example, a growth medium intended to be utilized in the form of a preformed, cohesive mat can include the particulate component and the fibrous component in a ratio of between about 1:4 by weight and about 1:2 by weight, for instance in a ratio of about 1:3 by weight.

The mixture can then be spread, either prior to or following addition of water, to form layer of a desired thickness, e.g., between about 0.25 inches and about 1 inch thickness. As the layer dries, the adhesive in the composite medium can bind the fibers of the layer to one another and the particulate components of the layer can be held in the mat, either through adhesive binding, through simple physical restraint within the fibrous matrix, or through some combination thereof. Following drying, the mat can retain its structure upon manipulation. Hence, a mat can be rolled, cut, unrolled, etc. without loss of components or loss of the three-dimensional structure of the mat.

In one embodiment, a mat can be formed on a surface and during drying, the mat can be lightly compressed to ensure uniform adhesion.

Drying can be merely atmospheric drying. Optionally, a mat can be treated with heat, radiation, and/or chemicals to sterilize and/or dry the mat. Following formation, the mat can be processed as desired. For example, a large mat can be cut into strips that can be rolled for storage and/or transportation. Rolled strips can be covered, for instance with a moisture resistant fabric or film, so as to retain moisture in the mat and provide for extended shelf life. Following transportation to a desired location, one or more mats can then be simply unrolled to apply the growth medium to the ground.

It will be appreciated that the foregoing examples, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention that is defined in the following claims and all equivalents thereto. Further, it is recognized that many embodiments may be conceived that do not achieve all of the advantages of some embodiments, yet the absence of a particular advantage shall not be construed to necessarily mean that such an embodiment is outside the scope of the present invention.

What is claimed is:

1. A composite growth medium comprising:
a particulate component, the particulate having a size between about 0.2 millimeters and about 2 millimeters, a density of between about 40 lbs/ft³ and about 50 lbs/ft³ at about 20% moisture content when compressed at a ratio of 5:1 on volume to volume basis, and a water holding capacity greater than about 50%;
a fibrous component, the fibers of the fibrous component being capable of absorbing greater than about 50% of their weight in water without loss of structure, the fibers having a length of between about one inch and about four inches.

2. The composite growth medium of claim 1, wherein the growth medium includes the particulate component and the fibrous component in a ratio of between about 4:1 and about 2:1.

3. The composite growth medium of claim 1, wherein the growth medium includes the particulate component and the fibrous component in a ratio of between about 1:4 and about 1:2.

4. The composite growth medium of claim 1, wherein the particulate component comprises coir pith.

5. The composite growth medium of claim 1, wherein the fibrous component comprises coconut fibers.

6. The composite growth medium of claim 5, wherein the coconut fibers are mattress fibers.

7. The composite growth medium of claim 1, the medium further comprising an adhesive.

8. The composite growth medium of claim 7, wherein the medium includes the adhesive in an amount of less than about 20% by weight of the medium.

9. The composite growth medium of claim 8, wherein the adhesive is a natural adhesive.

10. The composite growth medium of claim 1, the medium further comprising plant seed.

11. The composite growth medium of claim 10, wherein the plant seed is grass seed.

12. The composite growth medium of claim 1, the medium further comprising an insecticide.

13. The composite growth medium of claim 12, wherein the insecticide is an organic insecticide.

14. The composite growth medium of claim 1, the medium further comprising a fertilizer.

15. A composite growth medium comprising:
coir pith;
coconut mattress fibers; and
a natural adhesive.

16. The composite growth medium of claim 15, wherein the growth medium includes the coir pith and the coconut mattress fibers in a ratio of between about 4:1 and about 2:1.

17. The composite growth medium of claim 15, wherein the medium includes the adhesive in an amount of less than about 7% by weight of the medium.

18. The composite growth medium of claim 15, wherein the adhesive is guar gum.

19. The composite growth medium of claim 15, the medium further comprising grass seed.

20. The composite growth medium of claim 15, the medium further comprising an organic insecticide.

21. The composite growth medium of claim 20, wherein the organic insecticide is neem powder.

22. The composite growth medium of claim 15, the medium further comprising an organic fertilizer.

23. A method for improving the health and consistency of soil, the method comprising:
providing a composite growth medium, the medium including
a particulate component, the particulate having a size between about 0.2 millimeters and about 2 millimeters, a density of between about 40 lbs/ft³ and about 50 lbs/ft³ at about 20% moisture content when compressed at a ratio of 5:1 on volume to volume basis, and a water holding capacity greater than about 50%; and
a fibrous component, the fibers of the fibrous component being capable of absorbing greater than about 50% of their weight in water without loss of structure, the fibers having a length of between about one inch and about three inches, the growth medium including the particulate component and the fibrous component in a ratio of between about 4:1 and about 2:1; and
applying the composite growth medium to a ground surface, wherein the composite growth medium is applied to the ground surface at a density of greater than about 50 pounds solids per 1000 square feet of ground surface.

24. The method according to claim 23, wherein the growth medium is applied as a dried mixture.

25. The method according to claim 23, wherein the growth medium is applied as an aqueous slurry.

26. The method according to claim 23, wherein the growth medium is in the form of a structurally cohesive mat, the step of applying the growth medium to the ground surface comprising laying the cohesive mat across the ground surface.

27. The method according to claim 23, further comprising applying plant seed to the ground surface.

28. The method according to claim 23, the composite growth medium further comprising plant seed.

29. The method according to claim 23, the composite growth medium further comprising a component selected from the group consisting of an adhesive, an insecticide, a fertilizer, and combinations thereof.

30. The method according to claim 23, wherein the growth medium is applied to the ground surface at a density of greater than about 70 pounds solids per 1000 square feet of ground surface.
